(19) United States
(12) Patent Application Publication
(10) Pub. No.: US 2018/0087320 A1
(43) Pub. Date: Mar. 29, 2018

(54) WHEELED LADDER

(71) Applicant: Fire and EMS Consulting LLC, San Antonio, TX (US)

(72) Inventors: Ethan Lindner, San Antonio, TX (US); Shey Lindner, Covington, GA (US)

(21) Appl. No.: 15/682,105

(22) Filed: Aug. 21, 2017

Related U.S. Application Data
(60) Provisional application No. 62/377,391, filed on Aug. 19, 2016.

(51) Int. Cl. E06C 1/397; E06C 1/06; E06C 1/10; B62B 1/18; B62B 1/20

(52) U.S. Cl. CPC E06C 1/397; E06C 1/06; B62B 1/208; B62B 1/18; E06C 1/10

(57) ABSTRACT

A wheeled ladder may comprise a ladder having an axle disposed within a rung, and a wheel mounted at each end of the axle.

### CROSS-REFERENCE TO RELATED APPLICATION

This application claims priority to U.S. Provisional Patent Application No. 62/377,391 entitled “WHEELED LADDER” filed Aug. 19, 2016, the disclosure of which is hereby entirely incorporated herein by reference.

### BACKGROUND

Ladders, such as straight ladders, extension trestle ladders, extension ladders, and step ladders, may be unwieldy to manually move from location to location, particularly when carried with another load, such as tools or a human being requiring transportation. There exists a need for a method and apparatus for a system for enhancing the utility of a ladder.

### BRIEF DESCRIPTION OF THE DRAWINGS

FIG. 1 illustrates one embodiment of a wheeled ladder.

FIG. 2 illustrates a wheeled ladder leaning against a structure.

FIG. 3 illustrates a second embodiment of a wheeled ladder.

FIGS. 4, 4A, and 4B illustrate an axle and wheel assembly for disposition in a ladder rung.

FIG. 5 illustrates one example of use of a wheeled ladder.

### DETAILED DESCRIPTION

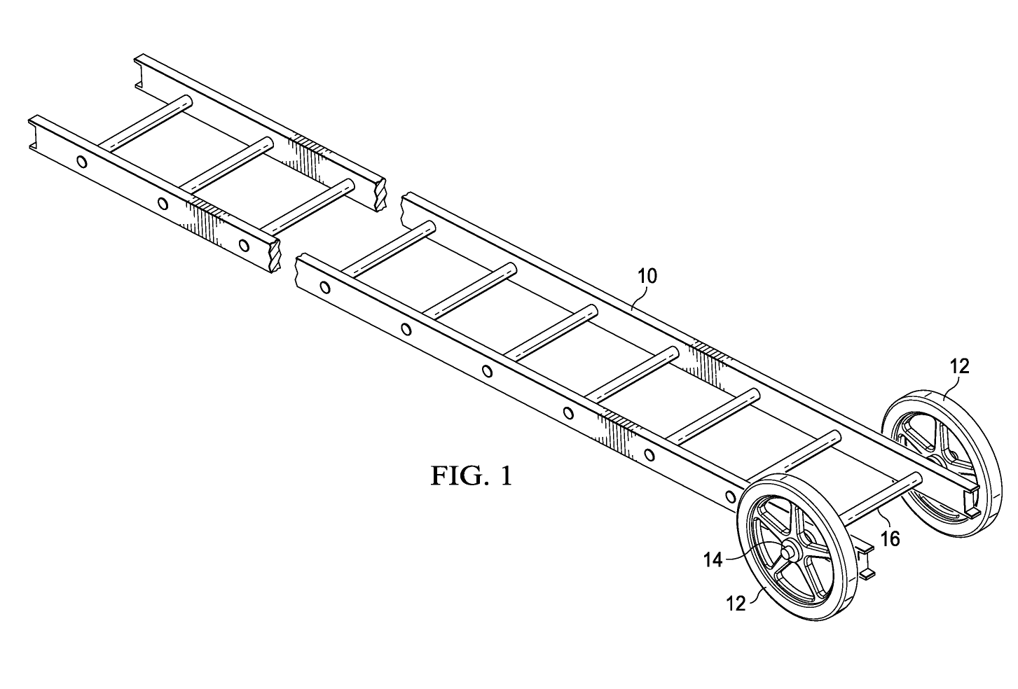

As may be seen in the wheeled ladder embodiment of FIG. 1, a ladder 10 may be provided with two wheels 12. Such a ladder 10 may be a straight ladder, extension ladder, extension trestle ladder, folding step ladder, or any other model of ladder that may be or fold flat. Said wheels 12 may be mounted to an axle 14 disposed through one of the rungs of the ladder 10. In the embodiment of FIG. 1, the axle 14 may be disposed in the first rung 16 of the ladder 10. The first rung 16 of a ladder 10 may be the rung located nearest to the end of the ladder 10 at which the wheels 12 are to be mounted. This rung may typically be the rung nearest the feet of the ladder, if such feet are a part of the ladder in question.

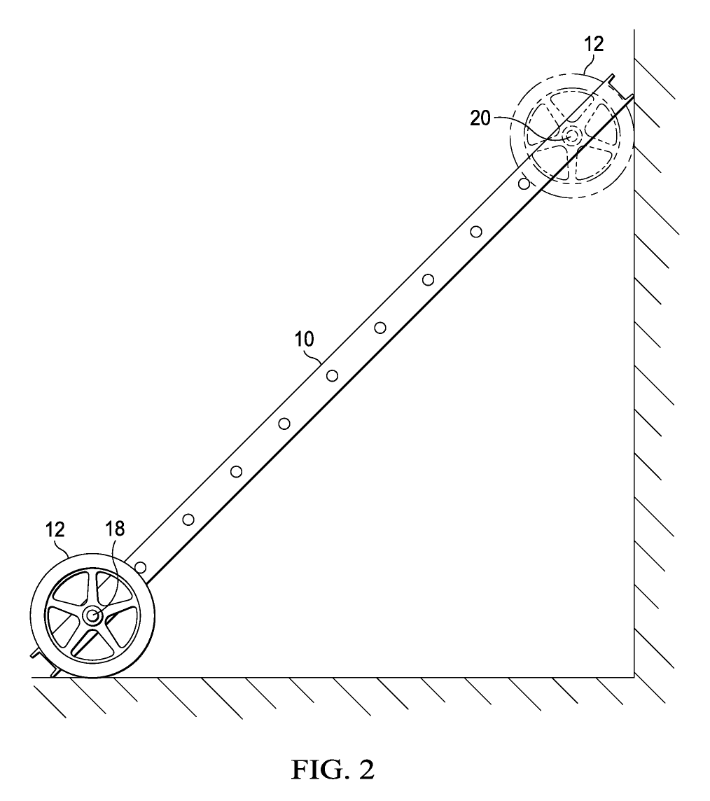

In FIG. 2, the bottom rung 18 of a ladder 10 may be the rung closest to the ground when the ladder leans against a structure, such as a building. The top rung 20 of a ladder 10 may be the highest rung of a ladder 10 when is leaned against a structure. A wheeled ladder 10 may be positioned against a structure so that the end of the ladder 10 at which the wheels 12 are mounted is supported on the ground, as may be seen in FIG. 2. Alternatively, wheeled ladder 10 may be positioned against a structure so that the end of the ladder 10 at which the wheels are mounted is supported by the structure.

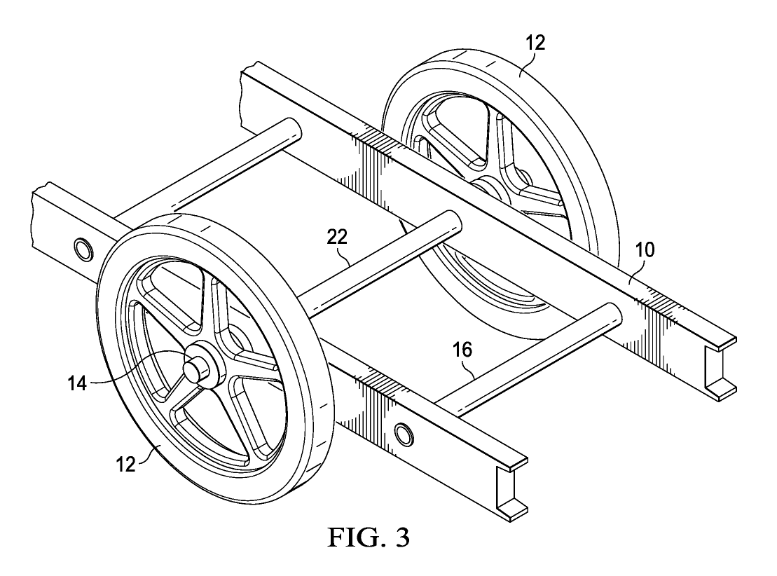

FIG. 3 provides a view of a second embodiment of a wheeled ladder 10. In this embodiment, two wheels 12 may be mounted to an axle 14 disposed in a second rung 22 of a ladder 10. The rung in which the axle is disposed may be selected based on wheel size, the intended use of the ladder, disposition of the wheels relative to the ladder rungs, or other factors such as regulatory or safety requirements. A larger wheel size may be desired to allow wheeled traverse of uneven terrain and over obstacles. For example, a wheel having an outer diameter of greater than 1½ feet may be mounted to an axle disposed through the second rung of a ladder. A wheel having an outer diameter of 6 inches may be disposed through the first rung of a ladder. A ladder having a smaller-diameter wheel may allow the ladder to lean against a structure with the wheeled end of the ladder to be either supported by a structure, or be supported by the ground.

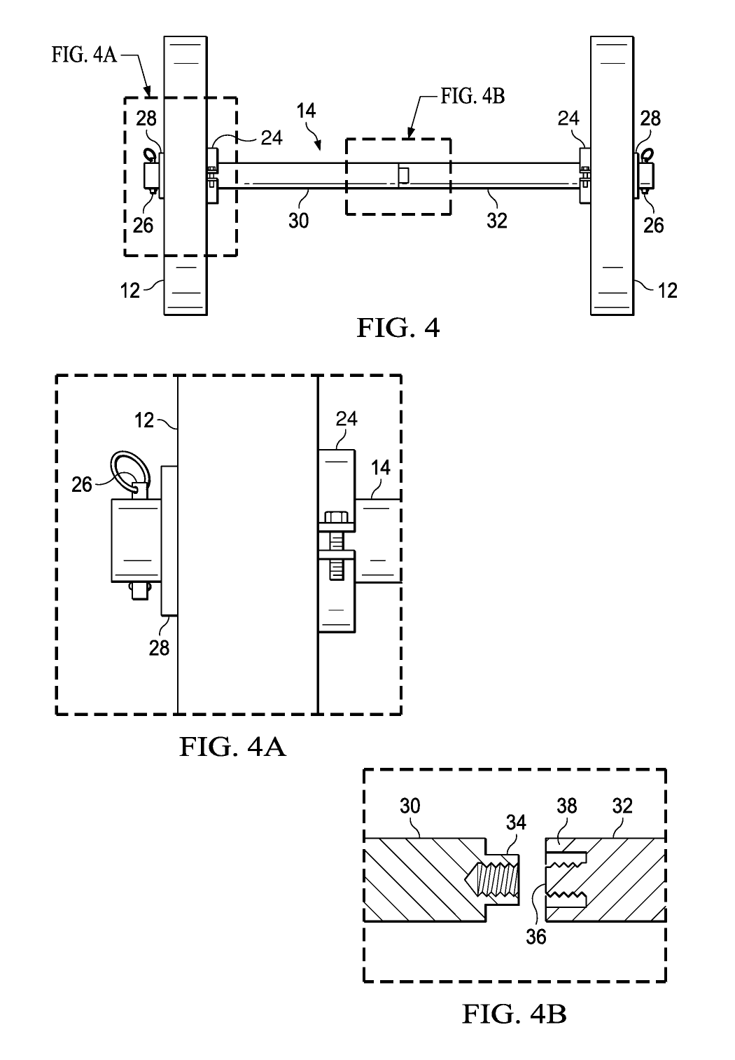

FIGS. 4, 4A, and 4B illustrate the wheels 12 mounted to the axle 14 separately from the ladder. In one embodiment, the axle 14 may not rotate within an axle rung to avoid unnecessary wear and tear on the ladder. In other embodiments, the axle 14 may rotate in the rung. Thus, the axle 14 may be sufficiently straight to extend through an axle rung, but of any suitable cross-sectional shape. As may be seen in the embodiment disclosed in FIG. 4, the axle 14 may be round. The axle 14 may be of any length suitable for disposition in a ladder. Thus, a suitable axle may be provided for ladders of any width.

At each end of the axle 14, inboard to the wheel 12, a collar 24 may be non-rotatably and non-translatably mounted to the axle 14 to prevent one side of a wheel 12 from contacting the ladder 10. The wheel 12 may rotate about the axle 14 against the collar 24. The collars 24 may be so mounted on an axle 14 as to substantially prevent translation of the axle 14 within the ladder rung when the axle 14 is disposed in the ladder rung.

The collar may be formed as a unitary part of the axle. Or, the collar may be a separate item of manufacture that may be removably or permanently mounted to the axle. A first washer (not shown) may be disposed between the wheel and the collar to reduce rotating friction between the wheel and the collar. In other embodiments, the wheel may rotate on the axle against the ladder body.

A wheel retainer 26 may be provided at the end of each axle 14, outboard to the tire 12, to retain the wheel 12 on the axle 14. As may be seen in the embodiment of FIG. 4, the wheel retainer 26 may comprise a cotter pin or hinge pin. In other embodiments, the wheel retainer 26 may comprise a threaded cap, or bolt, or axle nut. A second washer 28 may be disposed between the wheel retainer 26 and the wheel 12. The wheel 12 may rotate on the axle 14 against the washer 28. The collar 24, washer 28, and wheel retainer 26 may be more clearly seen in detail view A of FIG. 4.

As may be further seen in the embodiment of FIG. 4, the axle may comprise more than one section. The axle may be comprised of a first section 30 and a second section 32. The first section 30 and the second section 32 may be threadably joined (including by use of wire threads) so as to allow the axle 14 to be quickly mounted to or removed from a ladder. For example, as seen in detail view B of FIG. 4, one end of the first section 30 may comprise a reduced diameter post 34 containing female threads configured to receive a male threaded post 36 disposed at the end of the second axle section 32. The male threaded post 36 may be recessed inside the axle section 32 and so disposed within a thread shield 38. Such a thread shield may protect the male threaded post 36 from damage by the outer wall of the axle section 32. Additionally, by providing a thread shield 38 that co-acts with a corresponding reduced diameter female post 36, the joint formed by the two axle sections 30 and 32 may be strengthened.

In other embodiments, axle sections may be joined by any suitable fastener, such as a long bolt extending through the axle from end to end, or by use of ball detents, or pin engagement. In yet other embodiments, the axle sections need not be joined, but may be secured within the ladder rung by any suitable means, such as by friction fit, expandable bushings, expanding mandrel, expandable diameter bolt, expanding pin, adhesive, welding, cross-pin or other cross fastener, self-tapping threads or wire thread insert. Of course, such means may also be used to join together the axle sections.

In some embodiments, each end of the axle may be provided with a polygonal cross-section, such as a hexagon, so as to allow ready use of a wrench at each end to allow the axle sections to be suitably tightened together or loosened after use. For example, the axle end may be suitably configured for use with a fire hydrant wrench.

In further embodiments, the axle may be provided with a sleeve to protect the interior of a rung from abrasion or galvanic corrosion. A sleeve may comprise any suitably insulating or abrasion-resistant material, such as PTFE, Kevlar, silicone, or fiberglass, and may further be heat- or flame-resistant. A sleeve may be provided as a tube, or as a tape, or other suitable configuration. The axle may be suitably sized to accommodate a sleeve within a ladder rung.

By mounting wheels to a ladder, the ladder may be made more readily maneuverable by a single human. For example, long extension ladders may be advantageously provided with wheels as described herein to allow one person to move the ladder without assistance from another person.

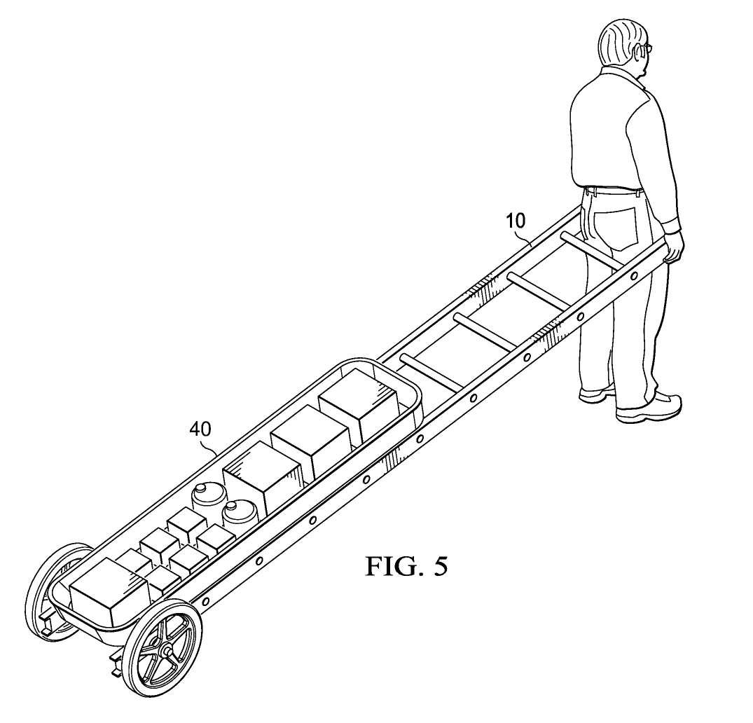

Similarly, providing wheels on a straight ladder may allow a single person to transport substantially heavier, larger or more unwieldy loads. As may be seen in the embodiment of FIG. 5, a load 40 may be placed on a ladder 10 close to the wheeled end. A person may lift the non-wheeled end and transport the load similarly to transporting a load with a wheelbarrow. The load may be any load suitable for carry in such a manner. For emergency applications, a rescue stretcher or litter basket carrying a human body may be placed on the ladder and affixed thereto for ready transport by one person. Additionally, a wheeled ladder may suitably carry a load of tools.

Deployment of a system described herein may accomplished quickly. A straight ladder may be placed on any relatively stable surface. An axle may be disposed in an axle rung, such as the first or second rung of the ladder. A wheel may be rotatably mounted to and retained at each end of the axle. If the axle comprises two connectable sections, then a wheel may be mounted to each section. The sections may then be inserted into a ladder rung and joined together.

A ladder wheel kit may be provided for mounting to any suitable ladder. A kit may comprise a single axle configured for disposition within a ladder rung, and two wheels mountable to each end. A kit may comprise an axle having two sections with wheels rotatably mounted to each section, with each section ready for insertion in a ladder rung.

In other embodiments, corresponding holes may be formed in a ladder frame so as to permit disposition of an axle as described above. In such embodiments, an axle may extend through the ladder substantially parallel to a rung.

Any suitable ladder that is flat or capable of being placed in a flat configuration may be enhanced by use of the axle and wheels as described herein. Although the foregoing embodiments have been illustrated in connection with a straight ladder, they may also be suitably adapted for use with an extension ladder, articulated ladder, combination ladder, or a step-ladder.

Although the disclosed subject matter and its advantages have been described in detail, it should be understood that various changes, substitutions and alterations can be made herein without departing from the invention as defined by the appended claims. Moreover, the scope of the claimed subject matter is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

We claim:

1. A wheeled ladder comprising:
a ladder having a plurality of rungs, the ladder being substantially flat or capable of folding to a substantially flat configuration;
an axle disposed through the ladder substantially parallel to a rung;
a first wheel rotatably mounted to a first end of the axle; and
a second wheel rotatably mounted to a second end of the axle.

2. The wheeled ladder of claim 1, the axle comprising a first section and a second section, the first section and second section being removably joined.

3. The wheeled ladder of claim 2, wherein the first section and the second section may be threadably joined.

4. The wheeled ladder of claim 2, wherein the axle is disposed in one of the plurality of ladder rungs.

5. The wheeled ladder of claim 4, wherein the axle is substantially non-translatably disposed in the rung.

6. The wheeled ladder of claim 6, wherein the axle is substantially non-rotatably disposed in the rung.

7. The wheeled ladder of claim 1, the ladder comprising a straight ladder, an extension ladder, an extension trestle ladder or a foldable step ladder.

8. The wheeled ladder of claim 2, wherein the axle is disposed through corresponding holes formed in the ladder frame.

9. A wheel kit for a ladder, the wheel kit comprising:
an axle configured for disposition in the rung of a ladder, the axle comprising a first section and a second section, the first section and the second section being configured for removably coupling together;
a first wheel rotatably and non-translatably mounted to the first section; and
a second wheel rotatably and non-translatably mounted to second section.

10. The wheel kit of claim 9, the first section and the second section being configured for threadable coupling together.

11. The wheeled kit of claim 10, the ladder comprising a straight ladder, an extension ladder, an extension trestle ladder or a foldable step ladder.

12. A method of using the kit of claim 9, the method comprising:
inserting the first section of the axle into a ladder rung from a first side of a ladder;
inserting the second section of the axle into the ladder rung from a second side of a straight ladder; and
coupling the first section to the second section.

13. The method of claim 12, further comprising decoupling the first section from the second section, and removing the first section of the axle and the second section of the axle from the ladder rung.
